(19) United States
(12) Patent Application Publication
(10) Pub. No.: US 2025/0292172 A1
(43) Pub. Date: Sep. 18, 2025

(54) PROCESS PLAN PREPARATION ASSISTANCE APPARATUS, PROCESS PLAN PREPARATION ASSISTANCE SYSTEM, AND PROCESS PLAN PREPARATION ASSISTANCE METHOD

(71) Applicant: Mitsubishi Electric Corporation, Chiyoda-ku, Tokyo (JP)

(72) Inventors: Yusuke SUGAHARA, Chiyoda-ku, Tokyo (JP); Toshiyuki HATTA, Chiyoda-ku, Tokyo (JP)

(73) Assignee: Mitsubishi Electric Corporation, Chiyoda-ku, Tokyo (JP)

(21) Appl. No.: 18/863,425

(22) PCT Filed: Nov. 1, 2022
(86) PCT No.: PCT/JP2022/040891

§ 371 Date: Nov. 6, 2024

(30) Foreign Application Priority Data
May 13, 2022 (JP) 2022-079193

(51) Int. Cl. G06Q 10/0631

(52) U.S. Cl. CPC G06Q 10/06314; G06Q 10/063118

(57) ABSTRACT

A process plan preparation assistance apparatus includes a personnel assignment calculator to calculate personnel assignment for an element operation corresponding to a production plan indicated by production plan information acquired based on operation time information for each operator, a process plan information generator generate process plan information indicating personnel assignment and a production sequence to maximize an evaluation value for productivity, and an operation time information updater to update the operation time information for an operator with a past operation record based on image information indicating an image of the operator, predict an element operation time of an operator with no past operation record based on the operation time information for an operator with a past operation record who has an attribute most similar to an attribute of the operator with no past operation record, and generate the operation time information for the operator with no past operation record.

### TECHNICAL FIELD

The present disclosure relates to a process plan preparation assistance apparatus, a process plan preparation assistance system, a process plan preparation assistance method, and a program.

### BACKGROUND ART

At a manufacturing site, operators who are assigned based on a manufacture article production plan receive instructions to perform operations with, for example, a method for acquiring information about the operation time of each of the operators and providing each operator with an efficient operation instruction that maximizes the evaluation value for productivity.

Patent Literature 1 describes a process plan preparation assistance apparatus that calculates an operation time of an operation entity assigned to each workstation included in an assembly line, calculates an evaluation index for each workstation based on the calculated operation time, and outputs the calculated evaluation index.

### CITATION LIST

### Patent Literature

Patent Literature 1: Unexamined Japanese Patent Application Publication No. 2018-26071

### SUMMARY OF INVENTION

### Technical Problem

The technique described in Patent Literature 1 may not allow efficient operation instructions to be provided to new operators, assistants, or other operators with operation times unknown due to a lack of data and thus with expected operation times unknown.

In response to the above issue, an objective of the present disclosure is to allow efficient operation instructions to be provided to operators with operation times unknown.

### Solution to Problem

To achieve the above objective, a process plan preparation assistance apparatus according to an aspect of the present disclosure includes a production plan information acquirer, a personnel assignment calculator, a process plan information generator, and an operation time information updater. The production plan information acquirer acquires production plan information indicating a production plan for a product. The personnel assignment calculator calculates personnel assignment for an element operation corresponding to the production plan indicated by the production plan information based on onsite-operator information, operation definition information, and operation time information. The onsite-operator information indicates an operator being onsite. The operation definition information indicates an element operation included in each process in a production process for the product. The operation time information indicates an element operation time taken for each operator to perform the element operation. The process plan information generator changes a production sequence, causes the personnel assignment calculator to calculate the personnel assignment, and generates process plan information indicating personnel assignment and a production sequence to maximize an evaluation value for productivity. The operation time information updater updates the operation time information for an operator with a past operation record based on image information indicating an image of the operator, predicts an element operation time of an operator with no past operation record based on the operation time information for an operator with a past operation record who has an attribute most similar to an attribute of the operator with no past operation record, and generates the operation time information for the operator with no past operation record.

### Advantageous Effects of Invention

The apparatus according to the above aspect of the present disclosure predicts, when preparing a process plan that maximizes the evaluation value for productivity based on the operation time of each operator, the element operation time of an operator with no past operation record based on the operation time information for an operator with a past operation record having the attribute most similar to the attribute of the operator with no past operation record, and generates operation time information indicating the element operation time of the operator with no past operation record to allow efficient operation instructions to be provided to operators with operation times unknown.

### BRIEF DESCRIPTION OF DRAWINGS

FIG. 1 is a schematic diagram of a process plan preparation assistance system according to Embodiment 1;

FIG. 2 is a functional block diagram of a process plan preparation assistance apparatus according to Embodiment 1;

FIG. 3 is a diagram of an example of operation time information in Embodiment 1;

FIG. 4 is a diagram of an example of operation definition information in Embodiment 1;

FIG. 5 is a functional block diagram of an example of an operation time information updater in Embodiment 1;

FIG. 6 is a diagram of an example of person attribute information in Embodiment 1;

FIG. 7 is a diagram of the person attribute information about a new operator X in Embodiment 1;

FIG. 8 is a conceptual diagram of a process of predicting an element operation time of the new operator X in Embodiment 1;

FIG. 9 is a graph illustrating an example probability distribution of the element operation time of the new operator X in Embodiment 1;

FIG. 10 is a flowchart of an example of a process plan preparation assistance process in Embodiment 1;

FIG. 11 is a flowchart of an example of an operation time prediction process in Embodiment 1; and

FIG. 12 is a diagram of a process plan preparation assistance apparatus according to Embodiments 1 and 2, illustrating an example hardware configuration.

### DESCRIPTION OF EMBODIMENTS

A process plan preparation assistance apparatus, a process plan preparation assistance system, a process plan preparation assistance method, and a program according to the present embodiment are described in detail with reference to the drawings. Like reference signs denote like or corresponding components in the drawings. An example operation of assisting in preparation of a process plan for assigning, to the operators, operations included in manufacture article production processes based on a manufacture article production plan is described in the embodiments below. A manufacture article is an example of a product.

### Embodiment 1

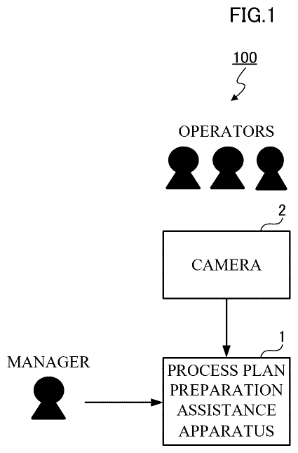

The structure of a process plan preparation assistance system 100 according to Embodiment 1 is described with reference to FIG. 1. A user (a manager in FIG. 1) of the process plan preparation assistance system 100 inputs production plan information indicating a manufacture article production plan for today into a process plan preparation assistance apparatus 1. The production plan information herein indicates the number of units to be produced for each manufacture article model. The information may not specify the production sequence. The manufacture article model is an example of a type of product.

A camera 2 records images of an operator. For example, the camera 2 may be a fixed three-dimensional (3D) camera that can record images of the hand of an operator during operation. The camera 2 transmits, to the process plan preparation assistance apparatus 1, image information indicating the recorded image of the operator.

The process plan preparation assistance apparatus 1 calculates personnel assignment for operations corresponding to the production plan based on the input production plan information and the received image information. The process plan preparation assistance apparatus 1 calculates the evaluation value for productivity based on the calculated personnel assignment. The process plan preparation assistance apparatus 1 changes the production sequence, performs personnel assignment, and calculates the personnel assignment and the production sequence that maximize the evaluation value for productivity. The process plan preparation assistance apparatus 1 outputs process plan information indicating the personnel assignment and the production sequence that maximize the evaluation value for productivity.

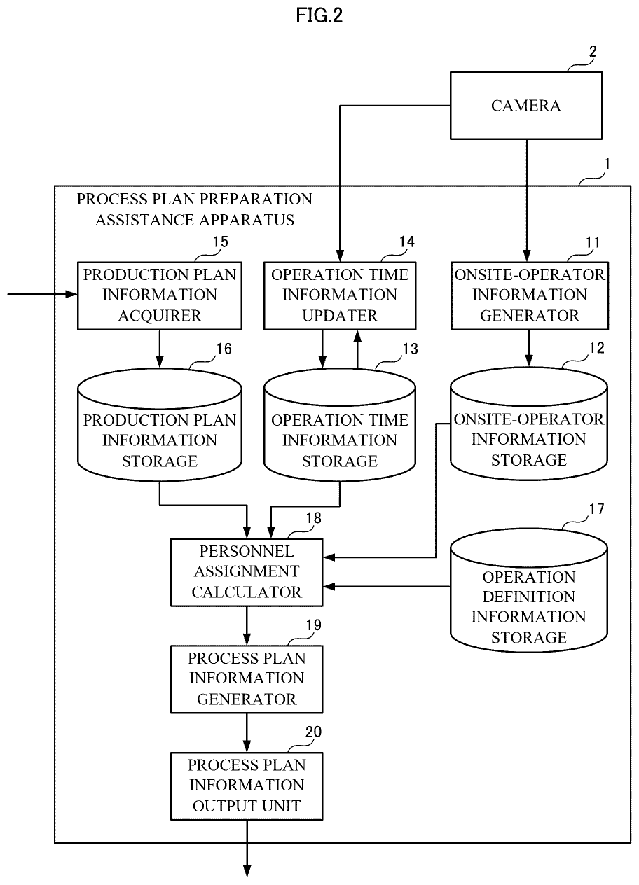

The functional components of the process plan preparation assistance apparatus 1 are described with reference to FIG. 2. The process plan preparation assistance apparatus 1 includes an onsite-operator information generator 11 that receives image information from the camera 2, identifies an operator being onsite based on the image information, and generates onsite-operator information indicating the operator being onsite, an onsite-operator information storage 12 that stores the onsite-operator information, an operation time information storage 13 that stores operation time information indicating the operation time of each operator, an operation time information updater 14 that receives the image information from the camera 2 and updates the operation time information based on the image information, a production plan information acquirer 15 that receives input of production plan information indicating a production plan for today from the user, a production plan information storage 16 that stores the production plan information, and an operation definition information storage 17 that stores operation definition information indicating the element operation included in the processes for each model.

The process plan preparation assistance apparatus 1 further includes a personnel assignment calculator 18 that calculates personnel assignment for operations corresponding to the production plan indicated by the production plan information based on the onsite-operator information, the operation time information, and the operation definition information, a process plan information generator 19 that calculates personnel assignment and a production sequence that maximize the evaluation value for productivity and generates the process plan information, and a process plan information output unit 20 that outputs the process plan information.

The onsite-operator information generator 11 acquires the name of an operator who is working onsite, or specifically, the name of an operator being onsite, by identifying a person in images indicated by the image information received from the camera 2. The onsite-operator information generator 11 generates onsite-operator information indicating the name of the operator being onsite, and stores the information into the onsite-operator information storage 12. A person in the images may be identified by, for example, reading an augmented reality (AR) marker specific to the operator or by facial recognition technology.

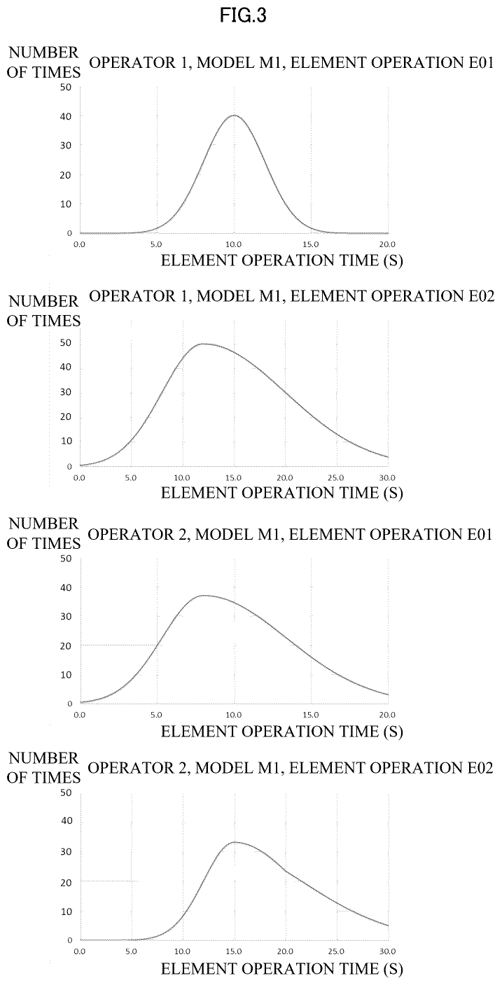

The operation time information storage 13 stores the operation time information indicating the operation time of each operator. The operation time information is described with reference to FIG. 3. In the example in FIG. 3, the operation time information is data storing the time taken for an element operation for each combination of the operator, the model, and the element operation. The time taken for the element operation is hereafter referred to as an element operation time. The element operation time indicated by the operation time information is not a constant but is a continuous probability distribution with the element operation time indicated by the horizontal axis and the number of times indicated by the vertical axis. FIG. 3 illustrates the probability distributions of the element operation times of a combination of an operator 1, a model M1, and an element operation E01, a combination of the operator 1, the model M1, and an element operation E02, a combination of an operator 2, the model M1, and the element operation E01, and a combination of the operator 2, the model M1, and the element operation E02.

For each combination of an operator, a model, and an element operation, operation time information indicating an element operation time based on a record is stored for an operator with a past operation record, whereas operation time information indicating a predicted element operation time is stored for an operator with no past operation record (e.g., a new operator or an assistant). A method for predicting an element operation time is described later. Any new operation record acquired for a combination of an operator, a model, and an element operation causes an update of the operation information.

Referring back to FIG. 2, the personnel assignment calculator 18 performs the personnel assignment that maximizes the evaluation value for productivity for the production plan (the model and the number of units) indicated by the production plan information based on the onsite-operator information, the operation time information, and the operation definition information. The personnel assignment refers to an assignment of an operator to an element operation included in each process for producing a manufacture article. The evaluation value for productivity is, for example, the value acquired by dividing the total number of production units by the total time of operators being onsite (units/hour). In this case, the productivity is higher as the number of units produced divided by the total time of operators being onsite (units/hour) is larger.

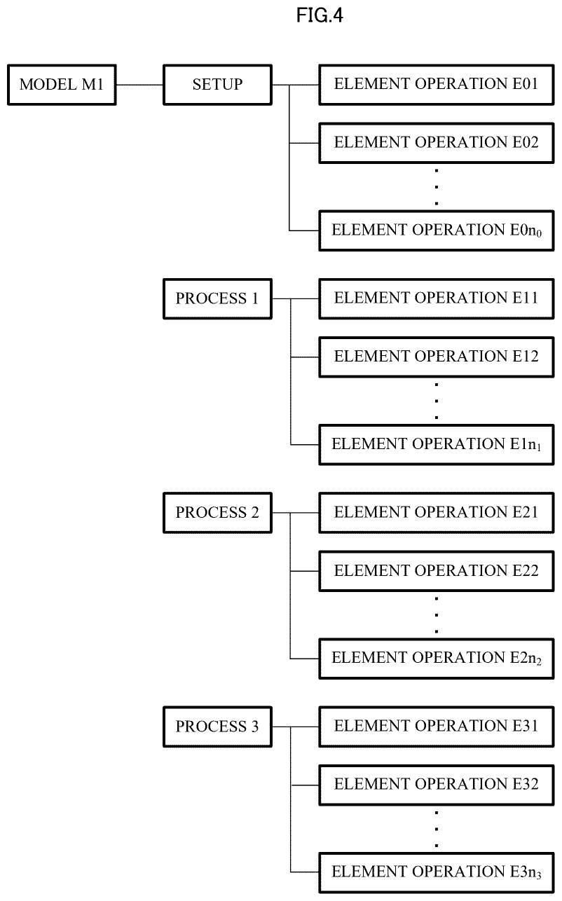

The operation definition information is described with reference to FIG. 4. In the example in FIG. 4, the operation definition information indicates the types of production processes including element operations for each model. The production process for the model M1 includes four processes, or setup, process 1, process 2, and process 3. The setup includes an element operation E01, . . . , an element operation E0n₀. Process 1 includes an element operation E11, . . . , an element operation E1n₁. Process 2 includes an element operation E21, . . . , an element operation E2n₂. Process 3 includes an element operation E31, . . . , an element operation E3n₃. For example, process 1 is a sub-assembly, process 2 is a characteristic test, and process 3 is total assembly. The element operation E01 in the setup is, for example, tool replacement, and the element operation E0n₀ is, for example, an entry operation. The element operation E11 in Process 1 is, for example, tool replacement, and the element operation E1n₁ is, for example, screwing. The element operation E21 in Process 2 is, for example, tool replacement, and the element operation E2n₂ is, for example, detachment of an inspector. The element operation E31 in Process 3 is, for example, tool replacement, and the element operation E3n₃ is, for example, transportation.

Referring back to FIG. 2, the process plan information generator 19 changes the production sequence for the model, and again causes the personnel assignment calculator 18 to perform the personnel assignment that maximizes the evaluation value. When the maximum evaluation value calculated by the personnel assignment calculator 18 exceeds the previous calculation result, the optimal solution for the personnel assignment and the production sequence is updated. The process plan information generator 19 repeats the above processing, compares all the maximum evaluation values calculated by the personnel assignment calculator 18, and generates process plan information using the personnel assignment and the production sequence that maximize the evaluation value as an optimal solution.

The process plan information output unit 20 outputs the process plan information generated by the process plan information generator 19. The process plan information may be output, for example, on a screen display or using sounds. Alternatively, the process plan information may be transmitted to a user terminal used by the user (the manager or the operator).

The operation time information updater 14 identifies the model and the person in the images indicated by the image information received from the camera 2 and measures the element operation time. The operation time information updater 14 updates the operation time information stored in the operation time information storage 13 based on the measured element operation time.

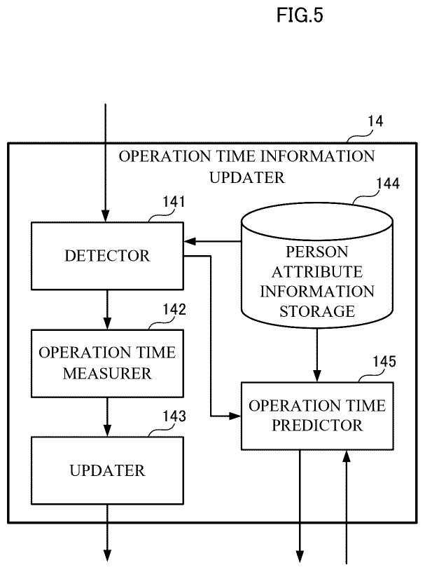

The functional components of the operation time information updater 14 are described with reference to FIG. 5. The operation time information updater 14 includes a detector 141 that detects an operator and a model of the manufacture article handled by the operator from the images indicated by the image information, an operation time measurer 142 that measures the element operation time of the operator, and an updater 143 that updates the operation time information based on the element operation time measured by the operation time measurer 142, a person attribute information storage 144 that stores person attribute information indicating the attributes of each operator with a past operation record, and an operation time predictor 145 that predicts the element operation time based on the person attribute information when an operator detected by the detector 141 has no past operation record (e.g., a new operator or an assistant).

The detector 141 detects the operator and the model of the manufacture article handled by the operator from the images indicated by the image information received from the camera 2. The detector 141 refers to the person attribute information stored in the person attribute information storage 144 and determines whether the detected operator has a past operation record. When the detected operator has a past operation record, the detector 141 transmits information indicating the detected operator and the detected model and the image information to the operation time measurer 142. When the detected operator is not an operator with a past operation record (e.g., a new operator or an assistant), the detector 141 transmits information indicating the detected operator and the detected model and the image information to the operation time predictor 145.

When receiving information indicating the operator and the model detected by the detector 141 and the image information, the operation time measurer 142 identifies the element operation performed by the operator based on the images indicated by the image information, and measures the element operation time of the operator. The element operation may be identified with, for example, a behavior classifier. The behavior classifier can divide a series of operation images automatically determined by artificial intelligence (AI) based on images of the operator during operation, and acquire the element operation time. When the element operation can be identified with a tool, an AR marker specific to the tool may be read to identify the element operation. The operation time measurer 142 transmits, to the updater 143, information indicating the operator and the model received from the detector 141 and information indicating the calculated element operation time.

The updater 143 updates, based on the information indicating the operator and the model received from the operation time measurer 142 and the information indicating the element operation time, the operation time information indicating a combination of the corresponding operator, model, and element operation included in the operation information stored in the operation time information storage 13.

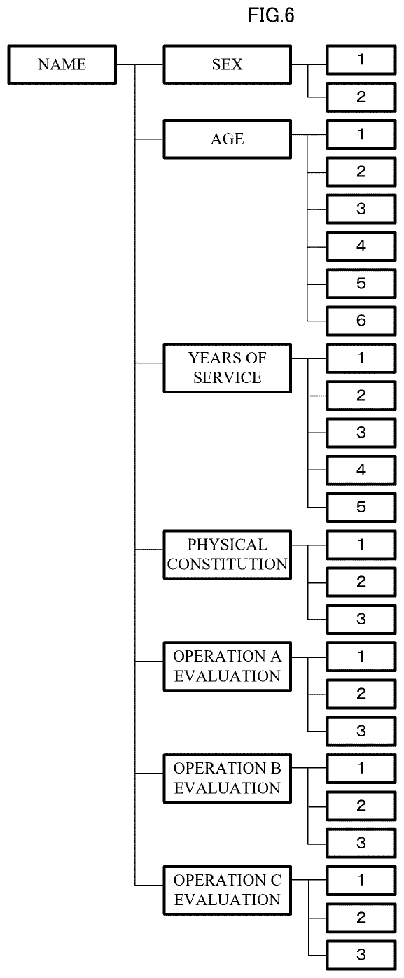

The person attribute information is described with reference to FIG. 6. The person attribute information stores the attributes of the operator and the values for the attributes. In the example in FIG. 6, the attributes of the operator include the name, sex, age, years of service, physical constitution, operation A evaluation, operation B evaluation, and operation C evaluation.

The value for sex is 1 for males and 2 for females. The value for age is 1 for 10 to 19 years old, 2 for 20s, 3 for 30s, 4 for 40s, 5 for 50s, and 6 for 60s and older. The value for the years of service is 1 for 10 years or less, 2 for 11 to 20 years, 3 for 21 to years, 4 for 31 to 40 years, and 5 for 41 years or more. The value for physical constitution is 1 for thin, 2 for standard, and 3 for obese. The operation A evaluation is evaluation of the speed at which the operation A can be complete. Similarly, the operation B evaluation is evaluation of the speed at which the operation B can be complete, and the operation C evaluation is evaluation of the speed at which the operation C can be complete. The operations A, B, and C include, for example, picking up of components, installation, screwing, electronic component insertion, bonding, soldering, and transportation. The value for each of the operation A evaluation, the operation B evaluation, and the operation C evaluation is 3 for fast, 2 for standard, and 1 for slow. The evaluation values for the operation A evaluation, the operation B evaluation, and the operation C evaluation are determined based on predetermined rules.

The values for the attributes of the operator in the person attribute information may not be limited to the values illustrated in FIG. 6. For example, age may be classified more finely in units of 5 years, or may be an exact age value. The years of service may be the value of continuous number of years in service. The physical constitution may be the body mass index (BMI) value calculated based on the height and weight. The attributes may include the evaluation value for the speed at which an operation other than the operations A, B, and C is complete. The person attribute information includes the attributes and the values for the attributes of an operator with no past operation record (e.g., a new operator or an assistant).

Referring back to FIG. 5, the operation time predictor 145 determines, based on the person attribute information, an operator with a past operation record similar to an operator with no past operation record (e.g., a new operator or an assistant) using a calculation formula. The operation time predictor 145 refers to the operation information about an operator with a past operation record similar to an operator with no past operation record (e.g., a new operator or an assistant) and predicts the element operation time of the operator with no past operation record.

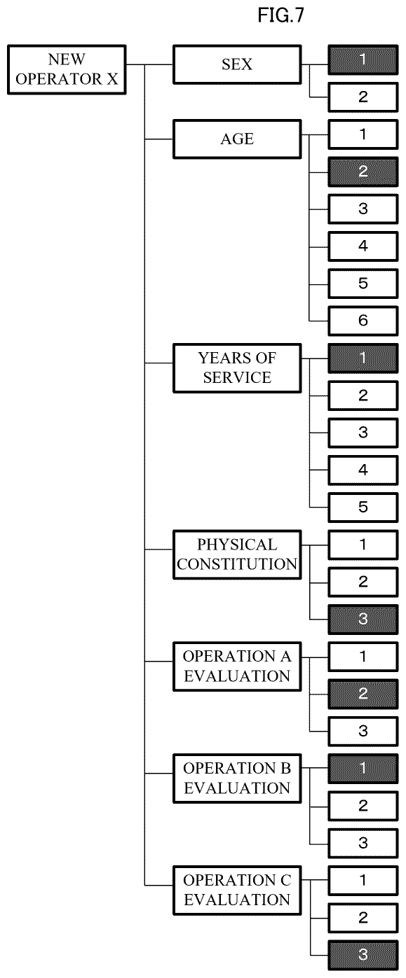

The element operation time of a new operator X who is an operator with no past operation record is predicted in the example described in detail below with reference to FIGS. 7 to 9. The operation time predictor 145 performs steps 1 to 4 to predict the element operation time of the new operator X. In step 1, a person (an operator with a past operation record) with the attributes most similar to the attributes of the new operator X is identified. In step 2, operation time information for the person is read from the operation time information storage 13. In step 3, the skill level is calculated inversely. In step 4, the probability distribution of the element operation time in the element operation on the model is calculated for the new operator X.

Step 1 is described first. The attribute values of the new operator X are denoted with a01, a02, . . . , a0N. In the example in FIG. 7, the attribute values of the new operator X are 1 for sex (male), 2 for age (20 s), 1 for years of service (10 years or less), and 3 for physical constitution (obese). The evaluation value is 2 for the operation A evaluation, 1 for the operation B evaluation, and 3 for the operation C evaluation. The attribute values of an operator i (i=1, 2, . . . , N) are denoted with ai1, ai2, . . . , aiN. A difference degree Si between the attributes of the new operator X and the operator i is expressed using Formula 1 below.

$${S}_{i} = {\sum }_{j = 1}^{n} {{k}_{j} ( {a}_{ij} - {a}_{0 j} )}^{2} \qquad Formula 1$$

The operation time predictor 145 determines that the operator i with the attributes having the smallest difference degree Si as an operator having the attributes most similar to the attributes of the new operator X. The coefficient kj (j=1, . . . , n) (0≤kj≤1) is a weighting coefficient for each attribute included in the person attribute information. A smaller value of kj represents the attribute that is more likely to affect the difference degree.

When the new operator X actually performs an operation and the operation time measurer 142 measures the element operation time, the operation time predictor 145 updates the coefficient kj (j=1, . . . , n) at predetermined timing. The coefficient kj (j=1, . . . , n) is updated in the manner described in detail later.

For example, the operation time predictor 145 outputs, as the initial values of the coefficients kj (j=1, . . . , n), k1=1.0 (sex), k2=0.5 (age), k3=0.5 (years of service), k4=0.7 (diagonal), k5=0.1 (operation A evaluation), k6=0.1 (operation B evaluation), and k7=0.1 (operation C evaluation). For these initial values, the coefficient kj of any attribute that is likely to have a high correlation in predicting the difference degree may be set low.

Although Formula 1 uses the least squares method for calculating the difference degree, the difference degree may be calculated with another method. For example, multiple regression analysis may be used.

In step 2, the operation time predictor 145 reads, from the operation time information storage 13, the operation time information for the operator i with the smallest attribute difference degree Si. The element operation time of the element operation on the model for the operator i selected in step 2 is the probability distribution resulting from the operator i with a skill level acquired in the element operation through experience. The new operator X has no such experience. In step 3, the skill level is thus calculated backward in predicting the element operation time of the new operator X. The skill level is typically expressed using Formula 2 below.

$$y ( x ) = cp \hat{} a ( x ) \qquad Formula 2$$

In the above formula, y(x) is the element operation time at the x-th production and x≥0, c is the element operation time of the first production and c≥0, and p is the skill rate and p=y(2x)/y(x). a(x)=log x/log 2.

The operation time predictor 145 acquires the probability distribution of the element operation time of the new operator X by dividing the probability distribution of the element operation time, at the current time (operation count x), of the operator i having the highest attribute similarity to the new operator X by the skill rate p. The skill rate p and the operation count x are values stored for each operator. The skill rate information indicating the skill rate p and the operation count x for each operator is stored in the person attribute information storage 144. As each operator experiences more operations, the skill rate p indicated by the skill level information is updated accordingly.

In step 4, a probability distribution graph of the element operation time in the element operation on the model are calculated for the new operator X. The operation time predictor 145 repeats steps 1 to 4 in the same manner to calculate the probability distribution graph of the element operation time of each new operator X for all models and all element operations.

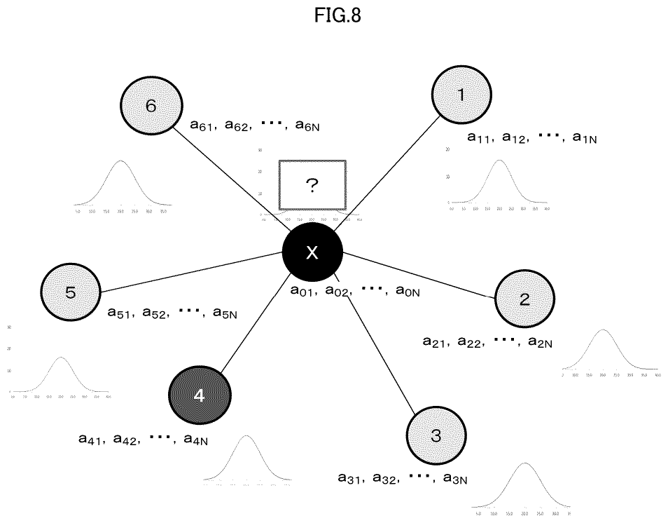

FIG. 8 is a conceptual diagram of a process of predicting the element operation time of the new operator X. In the example in FIG. 8, the operator i with the smallest attribute difference degree Si to the new operator X is an operator 4. In other words, the attributes of the operator 4 among the operators 1 to 4 are most similar to the attributes of the new operator X. The operation time predictor 145 acquires the probability distribution of the element operation time of the new operator X by dividing the probability distribution of the element operation time, at the current time, of the operator 4 having the highest similarity to the new operator X by the skill rate p.

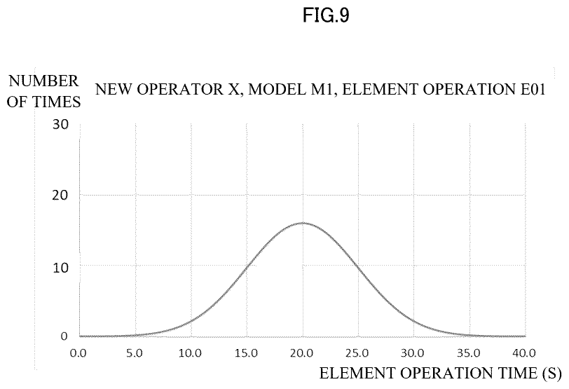

FIG. 9 is a graph illustrating an example probability distribution of the element operation time of the new operator X predicted by the operation time predictor 145. In the example in FIG. 9, the probability distribution indicates an element operation time for the combination of the new operator X, the model M1, and the element operation E01.

The operation time predictor 145 stores, into the operation time information storage 13, the operation information indicating the predicted probability distribution of each element operation time of the new operator X. When the new operator X performs operations a predetermined number of times, the operation time predictor 145 stores, into the operation time information storage 13, the operation information indicating the probability distribution of each element operation time of the operation performed by the new operator X. For example, the predetermined number of times may be 50 times. The operation information indicating the probability distribution of each element operation time of the operation performed by the new operator X is stored into the operation time information storage 13 to cause the new operator X to be an operator with an operation record.

The coefficient kj (j=1, . . . , n) is updated in the manner described in detail below. When the operation time predictor 145 generates operation time information for the new operator X, the operation time predictor 145 compares the element operation time predicted in advance with the element operation time based on the record, evaluates the accuracy, and updates the coefficient kj (j=1, . . . , n) that is used to predict the difference degree.

The probability density function predicted as an element operation time of the new operator X is denoted with f0(t), and the probability density function acquired as an element operation time of the new person X based on the record is denoted with fX(t), where t (0≤t) is a real number representing the element operation time. The operation time predictor 145 first evaluates the accuracy of prediction. The operation time predictor 145 calculates an evaluation value V for evaluation of the prediction accuracy based on the difference between the prediction and the record. The evaluation value V is calculated using Formula 3 below.

$$V = {\int }_{0}^{∞} \vert {f}_{X} ( t ) - {f}_{0} ( t ) \vert dt \qquad Formula 3$$

The operation time predictor 145 stores the evaluation value V as a history. The evaluation value V is smaller for higher prediction accuracy. When the predicted element operation time and the element operation time based on the record completely match, V=0.

The operation time predictor 145 then calculates a difference degree Vi to the element operation time of another operator i (i=1, . . . , N) using Formula 4 below, where fi(t) is the probability density function of the element operation time based on the record of the other operator i.

$$V = {\int }_{0}^{∞} \vert {f}_{X} ( t ) - {f}_{i} ( t ) \vert dt \qquad Formula 4$$

The operator with the smallest element operation time difference degree Vi (a person with the highest element operation time similarity to the new operator X) is an operator Y. The operation time predictor 145 uses Formula 1 for quantifying the attribute difference degree to calculate the attribute difference degree Si of the other operator i (i=1, . . . , N). The operation time predictor 145 calculates and updates the coefficients k1, . . . , kn that satisfy Formula 5.

$$\begin{matrix}{S}_{Y} ( = {\sum }_{j = 1}^{n} {{k}_{j} ( {a}_{ij} - {a}_{Yj} )}^{2} ) \to min \\ {S}_{Y} ≦ {S}_{1} , {S}_{Y} ≦ {S}_{2} , … , {S}_{Y} ≦ {S}_{N}\end{matrix} \qquad Formula 5$$

In Formula 5, kj (j=1, . . . , n) satisfies 0≤kj≤1. The coefficients k1, . . . , kn that satisfy Formula 5 may be calculated by, for example, setting each coefficient to three decimal places or smaller values and repeating search within a finite number of times to yield the optimal solution. The coefficient kj (j=1, . . . , n) is updated to the value with the smallest attribute difference degree SY to the operator Y, who has the smallest element operation time difference degree Vi. This causes the person with the highest element operation time similarity to the new operator X to also have the highest attribute similarity to the new operator X, thus improving the prediction accuracy of the element operation time in subsequent operations.

The process plan preparation assistance apparatus 1 updates the person attribute information stored in the person attribute information storage 144 and the operation definition information stored in the operation definition information storage 17 at predetermined timing.

For the person attribute information, for example, the values of attributes that change, such as age, years of service, physical constitution, operation A evaluation, operation B evaluation, and operation C evaluation, are updated based on the changes. When the process plan preparation assistance apparatus 1 stores information indicating the date of birth and the date of employment of an operator as information associated with the person attribute information, the age and the years of service can be updated automatically. The process plan preparation assistance apparatus 1 can also acquire information indicating the physical constitution of the operator and automatically update the physical constitution by, for example, linking with an in-house health management system that manages the health of the operator.

The operation definition information is edited and updated by the user when the configuration of an element operation included in each process in the production process for each model is changed at, for example, the start of production of a new model or at the time of manufacture article design change.

In the structure with which the user updates the operation definition information, the user may forget to update the information or may not notice changes in the configuration of the element operation. Thus, the process plan preparation assistance apparatus 1 may notify the user when the configuration of any element operation included in each process in the production process for each model may have been changed. For example, the camera 2 in the process plan preparation assistance system 100 records images of an operator during operation. The operation time information updater 14 in the process plan preparation assistance apparatus 1 identifies the operator, the model, and the element operation in the images indicated by the image information received from the camera 2. When the order of element operations actually performed by the operator on the model identified by the operation time information updater 14 differs from the order of element operations to be performed on the model indicated by the operation definition information, the process plan preparation assistance apparatus 1 notifies the user of a possible change in any element operation on the model.

The notification may be provided to the user by, for example, displaying a message on the screen, outputting a voice message, or transmitting a message to a user terminal used by the user. An edit screen for editing the operation definition information may be displayed together with a message to receive an edit from the user. The edit screen for the operation definition information may display a candidate element operation to be changed based on the order of element operations that are actually performed by the operator on the identified model.

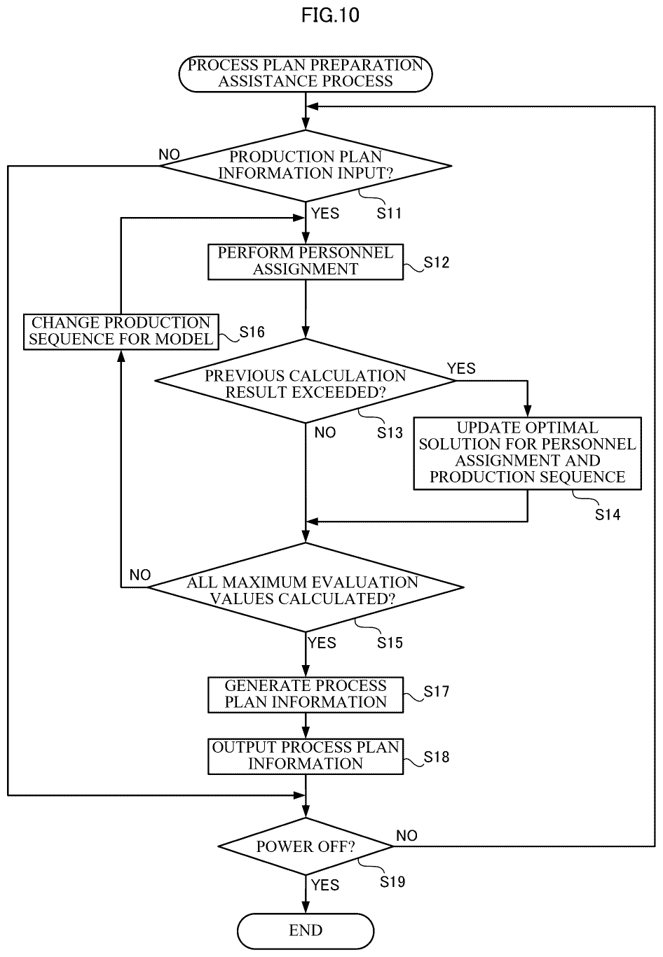

A process plan preparation assistance process performed by the process plan preparation assistance apparatus 1 is described with reference to FIG. 10. The process plan preparation assistance process illustrated in FIG. 10 starts when, for example, the process plan preparation assistance apparatus 1 is powered on. The production plan information acquirer 15 in the process plan preparation assistance apparatus 1 determines whether production plan information indicating a production plan for today is input (step S11). When no production plan information is input (No in step S11), the processing advances to step S19. When production plan information is input (Yes in step S11), the production plan information acquirer 15 stores the input production plan information into the production plan information storage 16. The personnel assignment calculator 18 performs the personnel assignment that maximizes the evaluation value for productivity for the production plan (the model and the number of units) indicated by the production plan information based on the onsite-operator information, the operation time information, and the operation definition information (step S12).

In the example in FIG. 3, the operation time information is data storing the element operation time for each combination of the operator, the model, and the element operation. The element operation time indicated by the operation time information is not a constant but is a continuous probability distribution with the element operation time indicated by the horizontal axis and the number of times indicated by the vertical axis. FIG. 3 illustrates the probability distributions of the element operation times of a combination of an operator 1, a model M1, and an element operation E01, a combination of the operator 1, the model M1, and an element operation E02, a combination of an operator 2, the model M1, and the element operation E01, and a combination of the operator 2, the model M1, and the element operation E02.

In the example in FIG. 4, the operation definition information indicates the types of production processes including element operations for each model. The production processes for the model 1 include four processes, or setup, process 1, process 2, and process 3. The setup includes an element operation E01, . . . , an element operation E0n₀. Process 1 includes an element operation E11, . . . , an element operation E1n₁. Process 2 includes an element operation E21, . . . , an element operation E2n₂. Process 3 includes an element operation E31, . . . , an element operation E3n₃.

Referring back to FIG. 10, the process plan information generator 19 determines whether the maximum evaluation value calculated by the personnel assignment calculator 18 exceeds the previous calculation result (step S13). When the calculation result does not exceed the previous calculation result or when no previous calculation result is stored (No in step S13), the processing advances to step S15. When the calculation result exceeds the previous calculation result (Yes in step S13), the process plan information generator 19 updates the optimal solution for the personnel assignment and the production sequence (step S14) and determines whether the personnel assignment calculator 18 has calculated all the maximum evaluation values (step S15).

When all the maximum evaluation values have not been calculated (No in step S15), the process plan information generator 19 changes the production sequence for the model (step S16). The processing returns to step S12, and the personnel assignment calculator 18 performs personnel assignment that maximizes the evaluation value. Steps S12 to S16 are repeated. When the personnel assignment calculator 18 has calculated all the maximum evaluation values (Yes in step S15), the process plan information generator 19 compares the maximum evaluation values calculated by the personnel assignment calculator 18, and generates process plan information (step S17) using the personnel assignment and the production sequence that maximize the evaluation value as an optimal solution.

The process plan information output unit 20 outputs the process plan information generated by the process plan information generator 19 (step S18). When the process plan preparation assistance apparatus 1 is not powered off (No in step S19), the processing returns to step S11. Steps S11 to S19 are repeated. When the process plan preparation assistance apparatus 1 is powered off (Yes in step S19), the process ends.

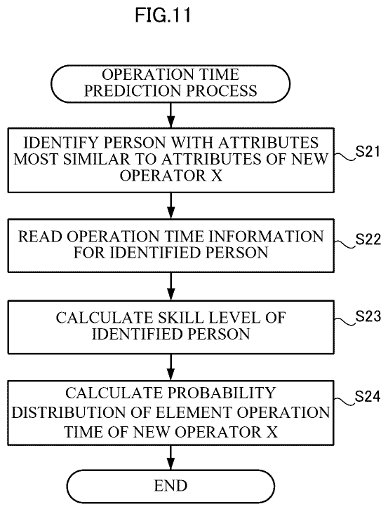

The operation time prediction process performed by the process plan preparation assistance apparatus 1 is described with reference to FIG. 11. The operation time prediction process illustrated in FIG. 11 starts when, for example, no past operation records of operators are detected by the detector 141 in the process plan preparation assistance apparatus 1. The operation time predictor 145 in the process plan preparation assistance apparatus 1 identifies a person (an operator with a past operation record) with the attributes most similar to the attributes of the new operator X (step S21).

In the example in FIG. 8, the person with the attributes most similar to the attributes of the new operator X is an operator 4.

Referring back to FIG. 11, the operation time predictor 145 reads the operation time information for the identified person from the operation time information storage 13 (step S22). The operation time predictor 145 calculates the skill level of the identified person (step S23). The probability distribution of the element operation time of the new operator X is calculated by dividing the probability distribution of the element operation time of the identified person at the current time (operation count x) by the skill rate (step S24). The process then ends.

In the example in FIG. 9, the probability distribution indicates an element operation time for the combination of the new operator X, the model M1, and the element operation E01.

The process plan preparation assistance apparatus 1 according to Embodiment 1 predicts, when preparing a process plan that maximizes the evaluation value for productivity based on the operation time of each operator, the element operation time of an operator without a past operation record based on the operation time information for an operator with a past operation record having attributes most similar to the attributes of the operator without the past operation record, and generates operation time information indicating the element operation time of the operator without the past operation record to allow efficient operation instructions to be provided to operators with operation times unknown. The element operation time is used in the probability distribution to be responsive to varying element operation times.

### Embodiment 2

In Embodiment 2, the operation time predictor 145 uses a prediction process different from the prediction process used in Embodiment 1. The other components are the same as in Embodiment 1. The element operation time of an operator is expressed using an exponential function model with a negative exponent using Formula 6 below.

$$y ( x ) = {p}^{- x} + c \qquad Formula 6$$

In the above formula, y(x) is the element operation time at the x-th production and x≥0, c is the element operation time of the first production and c≥0, and p is the skill rate, where y(x) is an element operation time of an operator performing the x-th production, and p is the skill rate of the operator to minimize the result from Formula 7.

$$\begin{matrix}D ( p ) {\sum }_{i = 1}^{N} {( y ( x ) - T ( x ) )}^{2} \\ = {\sum }_{i = 1}^{N} {( {p}^{- x} + c - T ( x ) )}^{2}\end{matrix} \qquad Formula 7$$

The number of decimal places in the skill rate p may be determined based on the accuracy intended by the user. The calculation time generally increases as the number of decimal places increases. As in Embodiment 1, the operation time predictor 145 acquires the probability distribution of the element operation time of the operator having no past operation records by dividing the probability distribution of the element operation time, at the current time (operation count x), of the operator having the highest attribute similarity to the operator having no past operation records by the skill rate p.

The process plan preparation assistance apparatus 1 according to Embodiment 2 increases the prediction accuracy using the skill rate that minimizes the difference between the element operation time calculated using the skill rate and the element operation time based on the records to predict the element operation time of an operator with no past operation records.

In Embodiments 1 and 2, the onsite-operator information generator 11 identifies a person in images indicated by the image information to acquire the name of an operator who is working onsite, or specifically, the name of an operator being onsite, and generates operator information indicating the name of the operator being onsite. However, the information may be generated in any other manner. For example, the onsite-operator information generator 11 may acquire the name of an operator who is working onsite, or specifically, the name of an operator being onsite, by identifying the person in a still image of the operator, and generate onsite-operator information indicating the name of the operator being onsite. The process plan preparation assistance apparatus 1 may acquire onsite-operator information in cooperation with an in-house management system that manages the start and end times of each operator.

In Embodiments 1 and 2 described above, the process plan preparation assistance apparatus 1 includes the operation time information storage 13, the onsite-operator information storage 12, and the operation definition information storage 17. These storages may be included in an external device or an external system. The operation time information storage 13 and the operation time information updater 14 may be included in an operation time information update device different from the process plan preparation assistance apparatus 1. Similarly, the onsite-operator information storage 12 and the onsite-operator information generator 11 may be included in an onsite-operator information generation device different from the process plan preparation assistance apparatus 1.

In Embodiments 1 and 2 described above, the production plan information acquirer 15 in the process plan preparation assistance apparatus 1 receives an input of production plan information indicating the manufacture article production plan for today. However, the information may be input in any other manner. The user may input production plan information indicating the manufacture article production plan for the day for which the process plan is to be prepared into the process plan preparation assistance apparatus 1. In some embodiments, when the user inputs the date on which the process plan is to be prepared (designated date) into the process plan preparation assistance apparatus 1 in cooperation with an in-house production plan system that manages the production plan, the production plan information acquirer 15 may acquire production plan information indicating the production plan of the designated date from the production plan system. The process plan may be prepared in units of other than one day, such as in units of a half day or two days.

Although Embodiments 1 and 2 each describe an example operation of assisting in preparation of a process plan for assigning, to the operators, operations included in manufacture article production processes, the operation is not limited to operations associated with manufacture articles. The manufacture articles may be any products involving predetermined operations included in the production processes.

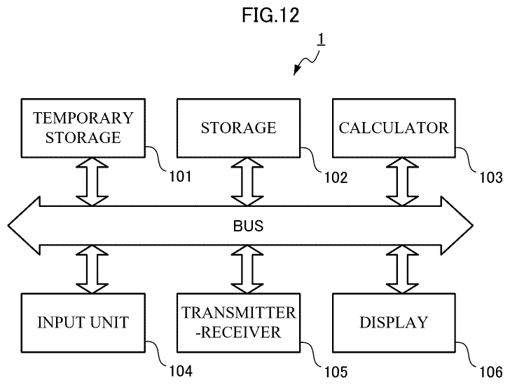

The hardware configuration of the process plan preparation assistance apparatus 1 is described with reference to FIG. 12. As illustrated in FIG. 12, the process plan preparation assistance apparatus 1 includes a temporary storage 101, a storage 102, a calculator 103, an input unit 104, a transmitter-receiver 105, and a display 106. The temporary storage 101, the storage 102, the input unit 104, the transmitter-receiver 105, and the display 106 are connected to the calculator 103 with a bus.

The calculator 103 is, for example, a central processing unit (CPU). The calculator 103 performs the processing of the onsite-operator information generator 11, the operation time information updater 14, the personnel assignment calculator 18, and the process plan information generator 19 based on the control program stored in the storage 102.

The temporary storage 101 is, for example, a random-access memory (RAM). The temporary storage 101 loads the control program stored in the storage 102 and is used as a work area for the calculator 103.

The storage 102 is a nonvolatile memory such as a flash memory, a hard disk drive, a digital versatile disc-random-access memory (DVD-RAM), and a digital versatile disc-rewritable (DVD-RW). The storage 102 prestores programs for causing the calculator 103 to perform the processing of the process plan preparation assistance apparatus 1, provides data stored in the program to the calculator 103 as instructed by the calculator 103, and stores data provided from the calculator 103. The onsite-operator information storage 12, the operation time information storage 13, the production plan information storage 16, and the operation definition information storage 17 are included in the storage 102.

The input unit 104 includes an input device, such as a keyboard, a pointing device, and a voice input device, and an interface that connects the input device to the bus. The information input by the user is provided to the calculator 103 through the input unit 104. The input unit 104 serves as the production plan information acquirer 15. In the structure in which the operation time information updater 14 displays an edit screen for editing the operation definition information together with a message and receives an edit from the user, the input unit 104 serves as the operation time information updater 14.

The transmitter-receiver 105 is a network terminator or a wireless communication device connected to a network, and a serial interface or a local area network (LAN) interface connected to the network terminator or the wireless communication device. In the structure in which the process plan information output unit 20 transmits process plan information to a user terminal used by the user (the manager or the operator), the transmitter-receiver 105 serves as the process plan information output unit 20.

The display 106 is, for example, a liquid crystal display (LCD) or an organic electroluminescent (EL) display device. In the structure in which the process plan information output unit 20 displays process information on the screen, the transmitter-receiver 105 serves as the process plan information output unit 20. In the structure in which the operation time information updater 14 displays an edit screen for editing the operation definition information together with a message and receives an edit from the user, the display 106 serves as the operation time information updater 14.

The processing of the onsite-operator information generator 11, the onsite-operator information storage 12, the operation time information storage 13, the operation time information updater 14, the production plan information acquirer 15, the production plan information storage 16, the operation definition information storage 17, the personnel assignment calculator 18, the process plan information generator 19, and the process plan information output unit 20 included in the process plan preparation assistance apparatus 1 illustrated in FIG. 2 are performed by the control program using, for example, the temporary storage 101, the calculator 103, the storage 102, the input unit 104, the transmitter-receiver 105, and the display 106 as resources.

The hardware configuration and the flowchart described above are mere examples, and may be changed or modified as appropriate.

The main components that perform the processing of the process plan preparation assistance apparatus 1 including the calculator 103, the temporary storage 101, the storage 102, the input unit 104, the transmitter-receiver 105, and the display 106 can be implemented by a common computer system instead of a dedicated system. For example, a computer program executable to implement the above operation may be stored in a non-transitory computer-readable recording medium, such as a flexible disk, a compact disc read-only memory (CD-ROM), or a DVD-ROM for distribution. The computer program may be installed in a computer to provide the process plan preparation assistance apparatus 1 that performs the above processing. The computer program may be stored in a storage device included in a server on a communication network, typically the Internet, and may be downloaded by a common computer system to implement the process plan preparation assistance apparatus 1.

When the functions of the process plan preparation assistance apparatus 1 are implementable partly by the operating system (OS) and application programs or through cooperation between the OS and the application programs, portions executable by the application programs may be simply stored in a non-transitory recording medium or a storage device.

The computer program may be superimposed on a carrier wave to be provided through a communication network. For example, the computer program may be posted on a bulletin board system (BBS) on a communication network to be provided through the communication network. The above processing may be performed by activating the computer program and executing the program in the same manner as the other application programs under the control of the OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-079193, filed on May 13, 2022, the entire disclosure of which is incorporated by reference herein.

### REFERENCE SIGNS LIST

1 Process plan preparation assistance apparatus
2 Camera
11 Onsite-operator information generator
12 Onsite-operator information storage
13 Operation time information storage
14 Operation time information updater
15 Production plan information acquirer
16 Production plan information storage
17 Operation definition information storage
18 Personnel assignment calculator
19 Process plan information generator
20 Process plan information output unit
100 Process plan preparation assistance system
101 Temporary storage
102 Storage
103 Calculator
104 Input unit
105 Transmitter-receiver
106 Display
141 Detector
142 Operation time measurer
143 Updater
144 Person attribute information storage
145 Operation time predictor

1. A process plan preparation assistance apparatus, comprising:
production plan information acquiring circuitry to acquire production plan information indicating a production plan for a product;
personnel assignment calculating circuitry to calculate personnel assignment for an element operation corresponding to the production plan indicated by the production plan information based on onsite-operator information, operation definition information, and operation time information, the onsite-operator information indicating an operator being onsite, the operation definition information indicating an element operation included in each process in a production process for the product, the operation time information indicating an element operation time taken for each operator to perform the element operation;
process plan information generating circuitry to change a production sequence, cause the personnel assignment calculating circuitry to calculate the personnel assignment, and generate process plan information indicating personnel assignment and a production sequence to maximize an evaluation value for productivity; and
operation time information updating circuitry to update the operation time information for an operator with a past operation record based on image information indicating an image of the operator, predict an element operation time of an operator with no past operation record based on the operation time information for an operator with a past operation record who has an attribute most similar to an attribute of the operator with no past operation record, and generate the operation time information for the operator with no past operation record.

2. The process plan preparation assistance apparatus according to claim 1, wherein
the operation time information updating circuitry includes
detecting circuitry to detect, from the image indicated by the image information, an operator and a type of a product handled by the operator,
operation time measuring circuitry to measure an element operation time of the operator based on the image information,
updating circuitry to update, when the operator detected by the detecting circuitry has a past operation record, the operation time information of the operator with the past operation record based on the operator and the type of the product handled by the operator detected by the detecting circuitry and the element operation time measured by the operation time measuring circuitry, and
operation time predicting circuitry to identify, when the operator detected by the detecting circuitry has no past operation record, an operator with a past operation record who has an attribute most similar to an attribute of the operator with no past operation record based on person attribute information indicating an attribute of each operator, predict an element operation time of the operator with no past operation record based on the operation time information of the identified operator, and generate the operation time information indicating the element operation time of the operator with no past operation record.

3. The process plan preparation assistance apparatus according to claim 2, wherein
the element operation time indicated by the operation time information is a probability distribution of each element operation time of each operator.

4. The process plan preparation assistance apparatus according to claim 3, wherein
the operation time predicting circuitry acquires the probability distribution of each element operation time of an operator with no past operation record by dividing the probability distribution of each element operation time, at a current time, of an operator with a past operation record who has an attribute most similar to an attribute of the operator with no past operation record by a skill rate of the operator with the past operation record who has an attribute most similar to an attribute of the operator with no past operation record.

5. The process plan preparation assistance apparatus according to claim 2, wherein
when the operator with no past operation record performs operations a predetermined number of times, the operation time predicting circuitry determines the operator with no past operation record to be an operator with a past operation record and generates the operation information based on the operator and the type of the product handled by the operator detected by the detecting circuitry and the element operation time measured by the operation time measuring circuitry.

6. The process plan preparation assistance apparatus according to claim 1, further comprising:
onsite-operator information generating circuitry to identify the operator being onsite based on the image information and generate the onsite-operator information.

7. A process plan preparation assistance system, comprising:
a camera to record an image of an operator; and
a process plan preparation assistance apparatus connected to the camera, the process plan preparation assistance apparatus including
production plan information acquiring circuitry to acquire production plan information indicating a production plan for a product,
personnel assignment calculating circuitry to calculate personnel assignment for an element operation corresponding to the production plan indicated by the production plan information based on onsite-operator information, operation definition information, and operation time information, the onsite-operator information indicating an operator being onsite, the operation definition information indicating an element operation included in each process in a production process for the product, the operation time information indicating an element operation time taken for each operator to perform the element operation,
process plan information generating circuitry to change a production sequence, cause the personnel assignment calculating circuitry to calculate the personnel assignment, and generate process plan information indicating personnel assignment and a production sequence to maximize an evaluation value for productivity, and
operation time information updating circuitry to update the operation time information for an operator with a past operation record based on image information indicating an image of the operator recorded by the camera, predict an element operation time of an operator with no past operation record based on the operation time information for an operator with a past operation record who has an attribute most similar to an attribute of the operator with no past operation record, and generate the operation time information for the operator with no past operation record.

8. A process plan preparation assistance method implementable with a process plan preparation assistance apparatus, the method comprising:
acquiring production plan information indicating a production plan for a product;
calculating personnel assignment for an element operation corresponding to the production plan indicated by the production plan information based on onsite-operator information, operation definition information, and operation time information, the onsite-operator information indicating an operator being onsite, the operation definition information indicating an element operation included in each process in a production process for the product, the operation time information indicating an element operation time taken for each operator to perform the element operation;
changing a production sequence, causing the personnel assignment to be calculated, and generating process plan information indicating personnel assignment and a production sequence to maximize an evaluation value for productivity; and
updating the operation time information for an operator with a past operation record based on image information indicating an image of the operator, predicting an element operation time of an operator with no past operation record based on the operation time information for an operator with a past operation record who has an attribute most similar to an attribute of the operator with no past operation record, and generating the operation time information for the operator with no past operation record.

9. (canceled)

10. The process plan preparation assistance apparatus according to claim 3, wherein
when the operator with no past operation record performs operations a predetermined number of times, the operation time predicting circuitry determines the operator with no past operation record to be an operator with a past operation record and generates the operation information based on the operator and the type of the product handled by the operator detected by the detecting circuitry and the element operation time measured by the operation time measuring circuitry.

11. The process plan preparation assistance apparatus according to claim 4, wherein
when the operator with no past operation record performs operations a predetermined number of times, the operation time predicting circuitry determines the operator with no past operation record to be an operator with a past operation record and generates the operation information based on the operator and the type of the product handled by the operator detected by the detecting circuitry and the element operation time measured by the operation time measuring circuitry.

12. The process plan preparation assistance apparatus according to claim 2, further comprising:
onsite-operator information generating circuitry to identify the operator being onsite based on the image information and generate the onsite-operator information.

13. The process plan preparation assistance apparatus according to claim 3, further comprising:
onsite-operator information generating circuitry to identify the operator being onsite based on the image information and generate the onsite-operator information.

14. The process plan preparation assistance apparatus according to claim 4, further comprising:
onsite-operator information generating circuitry to identify the operator being onsite based on the image information and generate the onsite-operator information.

15. The process plan preparation assistance apparatus according to claim 5, further comprising:
onsite-operator information generating circuitry to identify the operator being onsite based on the image information and generate the onsite-operator information.
